(19) United States
(12) Patent Application Publication
(10) Pub. No.: US 2004/0249997 A1
(43) Pub. Date: Dec. 9, 2004

(54) System and method for communicating data

(76) Inventors: Richard B. Umberhocker, Cedar Park, TX (US); Diego F. Vila, Austin, TX (US)

Correspondence Address: SPRINKLE IP LAW GROUP, P. O. BOX 684767, AUSTIN, TX, 78768-4767, US

(21) Appl. No.: 10/787,903

(22) Filed: Feb. 26, 2004

Related U.S. Application Data
(60) Provisional application No. 60/449,942, filed on Feb. 26, 2003.

(51) Int. Cl. G06F 3/00

(52) U.S. Cl. 710/29

(57) ABSTRACT

One embodiment of the present invention includes a system for communicating data comprising a device containing a flow-through buffer having a buffer capacity, a first data transport medium coupled to the device and a target coupled to the first data transport medium. The target device can be configured to, receive a data request from the device, send an initial set of data to the device that is smaller than the buffer capacity, delay a predetermined delay period, and send additional data to the device when the delay period has elapsed. By adjusting the amount of data sent in the initial data set and the delay period overfilling, and premature emptying of the flow-through buffer can be prevented or reduced.

### RELATED INFORMATION

This application claims priority under 35 U.S.C. § 119(e) to U.S. Provisional Patent Application No. 60/449,942, filed Feb. 26, 2003 entitled “System and Method for Extending the Read Window of Flow-Through Buffers,” which is hereby fully incorporated by reference.

### TECHNICAL FIELD OF THE INVENTION

The present invention relates generally to the field of communicating data between devices. More particularly, the present invention relates to systems and methods of communicating data in systems using a flow-through buffer.

### BACKGROUND

Devices in a computing system (e.g., personal computer, laptop, cell phone, controller, server, storage router or other computing system known in the art) communicate with each other using one or more busses. A bus provides a data transport medium between the central processing unit (“CPU”) or other processor, memory (e.g., RAM, ROM and other memory), storage devices, and peripheral device cards (i.e., the daughter boards that link the personal computer to other devices such as printers, speakers and so on) and other devices that make up or connect to the computing system.

One of the most ubiquitous buses is the industry standard architecture (“ISA”) bus. The ISA bus has been widely used in personal computers since the early 1980's and is still used in many PCs for linking peripheral devices to the CPU of the PC. As processor speeds have increased over the past several years, the ISA bus has become a bottleneck for data transfer in a computing system. Therefore, additional, faster buses have been developed. Examples of other buses include the extended ISA (“EISA”) bus, the Video Electronics Standards Association local bus (known as the “VESA local bus”, “VL-Bus” or “VLB”), the micro channel architecture (“MCA” bus), the peripheral component interconnect (“PCI”) bus, the PCI extended (“PCI-X”) and the advanced graphics port (“AGP”), which is an extension of the PCI bus architecture and is typically used to connect a high-performance video card to the CPU of a computing system. For various technological and business reasons the EISA, VLB and MCA busses have become largely obsolete and are found on few current computing devices. Therefore, the PCI bus has become the defacto standard for interconnecting devices of a computing system. Devices commonly connected to the PCI bus include, but are not limited to, network cards, hard drives and SCSI host adapters.

Devices that transfer data to other devices sometimes use an intermediate buffer located between the devices in order to temporarily store data until the receiving device can read the data. For example, if multiple PCI busses are used to link devices of a computer system, a PCI bridge can be employed to buffer data flowing between the busses. This allows a computing system to support more PCI devices or PCI card slots than can be supported with a single PCI bus. A PCI bridge typically comes configured with a flow-though buffer of a particular buffer size. The PCI bridge for a particular computing system is generally selected based on factors such as the time that data must be held in the buffer before it can read out and the cost of the PCI bridge.

FIG. 1 illustrates a typical interaction between devices communicating through a PCI bridge. A PCI initiator 10 can communicate with a PCI target 12 via a PCI bridge 14. PCI initiator 10 and PCI target 12 can be connected to PCI bridge 14 by the same or different PCI buses. In operation, PCI initiator 10 can send a data request 16 to request data from PCI target 12. PCI bridge 14 can receive the request and forward the request (represented by PCI request 18) to PCI target 12. PCI target, in response to PCI request 18, can return data 20. In some cases, PCI bridge 14 may not be able to communicate data to the PCI initiator 10 when the data is received by PCI bridge 14. To allow PCI initiator time to read the data, PCI bridge 14 can buffer the data. Because the data was not available at PCI bridge 14 when PCI initiator 10 originally requested the data, PCI initiator 10 will issue a data request retry 22. In response, PCI bridge 14 can allow PCI initiator 10 to access the data (represented by data 24).

In cases in which the buffer size at PCI bridge 14 is larger than the size of the data requested by PCI initiator 10, PCI bridge 14 can simply store the data in the buffer until PCI initiator 10 indicates that it is ready to read the data. However, the amount of data requested can often be larger than the buffer size. In this case, the PCI bridge is not able to store all of the requested data.

To handle a transfer of data that is larger than the PCI bridge's buffer size, many PCI bridges employ a “flow-through” buffer. In the example of FIG. 1, if PCI bridge 14 uses a flow-through buffer, PCI bridge 14 can receive and buffer data 20 from PCI target 12 until PCI initiator 10 begins to read the data from the flow-through buffer. Once this occurs, PCI bridge 14 can begin to forward data 24 from the flow-through buffer while continuing to fill the flow-through buffer with data 20. In other words, the flow-through buffer can be emptying data to the PCI initiator while receiving requested data from the PCI target. Flow-through (i.e., emptying the buffer while filling the buffer) allows the size of the data flowing through the buffer to larger than the actual buffer size.

Some popular PCI bridges that use flow-through buffers will stop the transfer of data if the buffer overfills. Overfilling can occur when PCI target 12 sends more than enough data to fill the flow-through buffer at PCI bridge 14 before PCI initiator 10 begins reading the data. As an example, if PCI bridge 14 has a 64 byte flow-through buffer, but PCI target 12 sends 128 bytes of data before PCI initiator 10 is ready to receive data, the flow-through buffer at PCI bridge 14 will not be able to store all the data at any one time. Overfilling can also occur if PCI initiator 10 can not read data from the flow-through buffer as quickly as PCI target 12 can fill the flow-through buffer. Once PCI bridge 14 receives more data than it can buffer, it will disconnect from PCI target 12, thereby interrupting the data transfer. In order to receive all of the requested data, PCI initiator 10 will have to send a new data request.

FIG. 2 is a diagrammatic representation illustrating the transfer of data between a PCI initiator and PCI target through a PCI bridge that disconnects from the PCI target when the flow-through buffer of the PCI bridge becomes filled. In the example of FIG. 2, it is assumed that (i) there are three PCI initiators attempting to take control of the PCI bus to which they are connected by making requests to PCI targets, (ii) the overhead for each request is 64 bytes and (iii) the flow-through buffer at the PCI bridge has 64 bytes of storage. Each of the three PCI initiators can attempt to take control of the initiator side PCI bus (i.e., participate in “bus mastering”), by sending data request 26, data request 28 and data request 30, respectively. Because data request 26 is the first data request, the associated PCI initiator can gain control of the initiator side PCI bus. The PCI target will, consequently, receive the corresponding data request (represented by 26′) from the PCI bridge. The PCI target can then send PCI data 36 to the PCI bridge.

When PCI data 36 arrives at the bridge the bridge the bridge will wait for a data request retry 32 from the first initiator before sending the data to the initiator. If the bridge does not receive data request retry 32 before the flow-through buffer becomes full, the PCI bridge will disconnect from the PCI target. Because the PCI bridge disconnected from the PCI target, the PCI target will wait until the next PCI data request (represented by request 40 on the initiator side and 40′ on the target side) to request additional data from the PCI target and will have to wait for a second data request retry to forward the additional data to the PCI initiator.

The period between when data is no longer sent to the PCI bridge (line 38) and the next data request 40 is received, represents a delay 42 in which no data is transferred from the target to the bridge, resulting in a loss in efficiency. In the example of FIG. 2, if the flow-through buffer size is 64 bytes and the administrative overhead for each request is equal to the time it takes to read 64 bytes, the efficiency of the data transfer of FIG. 3 is only 20% ((64 bytes of data)/(64 bytes of data+64 bytes of overhead * three requests+64 bytes for the data request retry)). If the initiator side bus and target side bus are each 64 bit/66 MHz busses, the effective data throughput would be approximately 528*0.2=105 MB/s. Thus, traditional systems using flow-through buffers can be inefficient at transferring data between a target and an initiator.

### SUMMARY OF THE INVENTION

Embodiments of the present invention provide systems and methods of data communication that eliminate, or at least substantially reduce, the shortcomings of prior art data communications systems and methods that use flow-through buffers. One embodiment of the present invention includes a system for communicating data comprising a device containing a flow-through buffer having a buffer capacity, a first data transport medium coupled to the device and a target coupled to the first data transport medium. The target device can be configured to receive a data request from the device, send an initial set of data to the device that is smaller than the buffer capacity, delay a predetermined delay period, and send additional data to the device when the delay period has elapsed.

The system can further comprise a second data transport medium coupled to the device and an initiator coupled to the second data transport medium. The initiator can be configured to generate the data request, send the data request to the device, and receive data from the flow-through buffer. According to one embodiment of the present invention, the predetermined delay period can be configured to allow the initiator to begin receiving data from the flow-through buffer before the target sends the additional data.

Another embodiment of the present invention can include a method of communicating data comprising, at a target: sending an initial set of data to a device containing a flow-through buffer with a buffer capacity, wherein the amount of data in the initial set of data is less than the buffer capacity, waiting to send additional data to the device containing the flow-through buffer for a predetermined delay period and sending the additional data to the device containing the flow-through buffer after the predetermined delay period. The method can further include, at the device containing the flow-through buffer: receiving the data request from an initiator, forwarding the data request to the target, receiving the initial set of data from the target, storing the initial set of data in the flow-through buffer, communicating data in the flow-through buffer to the initiator, receiving at least a portion of the additional data from the target before the flow-through buffer is empty, storing the at least a portion of the additional data in the flow-through buffer and continuing to send data in the flow-through buffer to the initiator according to a flow-through mode.

Yet another embodiment of the present invention can include a device for communicating data comprising a data buffer for storing data, a PCI controller configured to control transmission of data from the data buffer, an initial data set timer circuit coupled to the PCI controller, and a delay period timer circuit coupled to the PCI controller. The PCI controller can be responsive to a data request to send an initial set of data from the data buffer to a device containing a flow-through buffer for a period of time governed by the initial data set timer circuit. The PCI controller can also be configured to delay sending additional data to the device containing the flow-through buffer for a delay period governed by the delay period timer circuit.

Embodiments of the present invention provide an advantage over prior art systems and methods of communicating data in a system with a flow-through buffer by preventing overfilling of the flow-through buffer.

Embodiments of the present invention provide another advantage over prior art systems and methods of communicating data in a system with a flow-through buffer by preventing the flow-through buffer from becoming empty before additional data can be sent to the flow-through buffer.

Embodiments of the present invention provide yet another advantage by increasing the effective bandwidth of systems that use flow-through buffers. This can allow smaller, cheaper devices that include a flow-through buffer to be utilized in systems that have higher bandwidth requirements.

### BRIEF DESCRIPTION OF THE DRAWINGS

A more complete understanding of the present invention and the advantages thereof may be acquired by referring to the following description, taken in conjunction with the accompanying drawings in which like reference numbers indicate like features and wherein:

FIG. 1 illustrates a typical interaction between devices communicating through a PCI bridge;

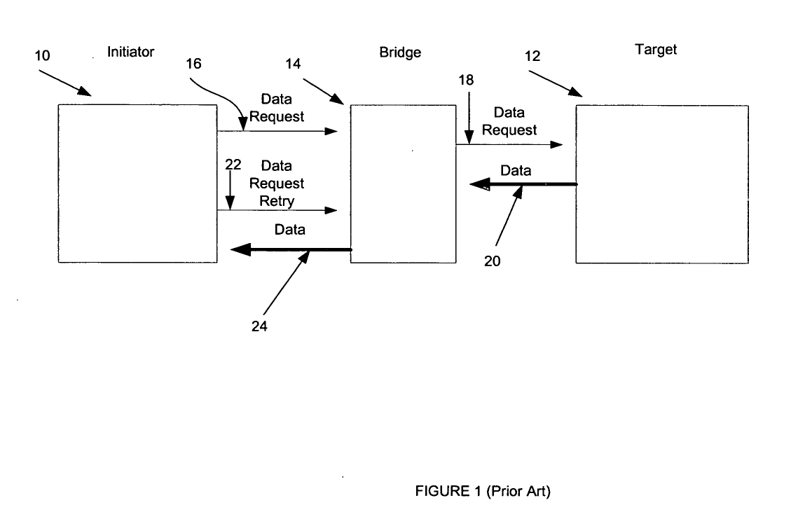

FIG. 2 is a diagrammatic representation illustrating the transfer of data between a PCI initiator and PCI target through a PCI bridge that disconnects from the PCI target when the flow-through buffer of the PCI bridge becomes filled;

FIG. 3 is a diagrammatic representation of a system for transferring data between devices according to one embodiment of one embodiment of the present invention;

FIG. 4 is a diagrammatic representation of a data flow according to one embodiment of the present invention;

FIG. 5 is a flow chart illustrating one embodiment of a method for transferring data from a target to an initiator using a flow-through buffer; and

FIG. 6 is a diagrammatic representation of one embodiment of a system for transmitting data from a PCI target to a PCI bridge that includes a flow-through buffer.

### DETAILED DESCRIPTION OF THE INVENTION

Preferred embodiments of the invention are illustrated in the FIGURES, like numerals being used to refer to like and corresponding parts of the various drawings.

Embodiments of the present invention provide methods and systems for extending the flow-through window of a buffer. One embodiment of the present invention can include a system that has an initiator that makes a request for data, a target that returns data in response to the request and a device with a flow-through buffer (e.g., a bridge or other device with a flow-through buffer) located, with respect to data flow, between the target and initiator. A first data transport medium (e.g., a PCI bus) can connect the target to the bridge, and a second data transport medium (e.g., a second PCI bus) can connect the initiator to the bridge. The bridge can have a flow-through buffer for storing data sent from the target to the initiator. In a flow-through mode of operation, the bridge can communicate data from the flow-through buffer to the initiator while adding data from the target to the flow-through buffer. The data can be communicated to the initiator by sending data to the initiator or allowing data to be read from the flow-through buffer.

The target, in response to a data request, can be configured to send an initial set of data to the bridge that is smaller in amount than the buffer capacity. In other words, the target can send an initial set of data that will not overfill the flow-through buffer at the bridge. The target can then delay for a preset period of time (i.e., a delay period) and then send additional data to the bridge. The delay period can be configured such that the target will delay sending data to the bridge for a sufficient period of time to allow the initiator to begin reading data from the bridge. By inserting a delay period that allows the initiator to begin reading data from the flow-through buffer, preventing overfilling of the flow-through buffer by sending additional data can be prevented when the additional data is sent to the flow-through buffer. It should be noted that each of the target, initiator and device with the flow-through buffer can be a device comprising a single component (e.g., a single chip) or multiple components working together.

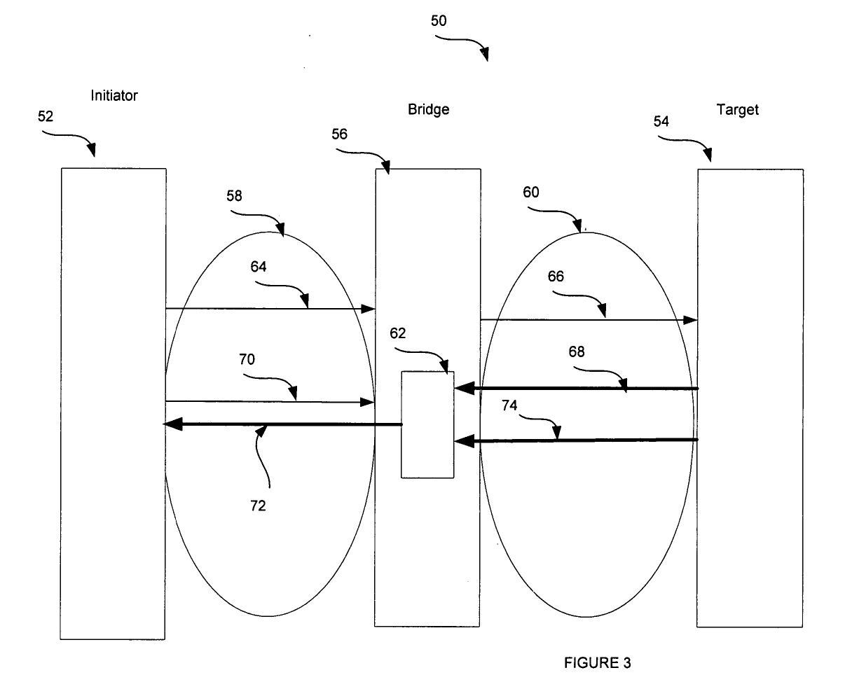

FIG. 3 is a diagrammatic representation of a system 50 for transferring data between devices according to one embodiment of one embodiment of the present invention. System 50 can include an initiator 52, a target 52 responsive to a data request to return data to the initiator and a bridge 56. Initiator 52 can be coupled to bridge 56 by a first data transport medium 58 (initiator side bus 58) and target 54 can be coupled to bridge 56 by a second data transport medium 60 (target side bus 60). For the sake of example, but not limitation, FIG. 3 will be discussed in terms of transferring data between PCI devices. Accordingly, initiator 52 can be a PCI initiator 52, such as an LSI 53C1010 SCSI chip (LSI is a trademark of LSI Logic Corp. of Milpitas, Calif.), target 54 can be a PCI target 54, such as a PCI memory controller implemented as programmed logic in an Altera 20K400E Field Programmable Gate Array (Altera is trademark of Altera Corporation of San Jose Calif.), bridge 56 can be a PCI bridge 56, such as an Intel 21154 PCI bridge (Intel is a trademark of Intel Corporation of Santa Clara, Calif.), the first data transport medium and second data transport medium can be PCI busses (e.g., 32 bit, 64 bit, 33 MHz, 66 MHz busses or other PCI busses known in the art). Each PCI bus can include control lines, data lines, address lines and logic to govern access to the PCI bus. The logic for controlling access to a particular PCI bus can be implemented in the PCI bridge or other device (e.g., a system controller, a chipset or other location). PCI bridge 56 can include flow-through buffer 62, as would be understood by those of ordinary skill in the art, and can operate in a flow-through mode of operation in which PCI bridge 56 can send data to PCI initiator 52 from flow-through buffer 62, while adding data from target 54 to flow-through buffer 62.

In operation, PCI initiator 52 can send a data request 64 destined for target 54 over initiator side bus 58. PCI bridge 56 can receive the data request and forward the data request to PCI target 54 via target side bus 60 (represented by request 66). In response to request 66, PCI target 54 can return an initial set of data 68 to PCI bridge 56. PCI target 54 can be configured such that initial set of data 68 is smaller than the buffer capacity of flow-through buffer 62. PCI target 54 can then wait for a predetermined delay period before sending additional data 74 to PCI bridge 56.

PCI initiator 52 can send a data request retry 70 to PCI bridge 56 and, in response, PCI bridge 56 can send data 72 from flow-through buffer 62 to PCI initiator 52. As additional data 74 is added to flow-through buffer 62, PCI bridge 56 can forward the data to PCI initiator 52. Accordingly, when PCI target 54 sends additional data 74 to PCI bridge 56 after a predetermined delay period, PCI bridge 56 can send additional data 74 to PCI initiator 52 in a flow-through manner without having to receive an additional data request from PCI initiator 52.

Thus, PCI target 54 can send an initial set of data 68 to PCI bridge 56 that will not overfill flow-through buffer 62 of the bridge, delay for a predefined period of time and send additional data 74 to PCI bridge 56. According to one embodiment of the present invention, PCI target 54 can delay sending additional data 74 for a sufficient period of time to allow PCI initiator 52 to begin receiving data from PCI bridge 56. In this embodiment of the present invention, PCI target 54 will send initial set of data 64 to PCI bridge 56, delay a period of time to allow PCI initiator 52 to begin reading data from flow-through buffer 62, and send additional data 74 to PCI bridge 56.

The amount of delay period and amount of data in the initial set of data can be established based on the relative speeds at which data can be entered into or read from the flow-through buffer. The target side initiator side bandwidths can be based on the bus configuration, target configuration and initiator configuration. Initiator side bus 58 and target side bus 58 can be symmetrical (i.e., can have approximately the same width and speed) or can be asymmetrical (i.e., can operate at different widths or speeds). Furthermore, PCI initiator 52 can be capable of reading data from flow-through buffer 62 at the same rate that PCI target 54 can fill flow-through buffer 62, at a faster rate or at a slower rate.

In the case in which PCI initiator 52 can read data from flow-through buffer 62 more quickly than PCI target 54 can fill flow-through buffer 62, the delay period between sending the initial set of data and the additional data can be relatively short to prevent the flow-through buffer from becoming empty. In the case in which the PCI initiator reads data from flow-through buffer 62 more slowly than PCI target 54 fills flow-through buffer 62, the delay period can be set sufficiently long to prevent flow-through buffer 62 from becoming overfilled and additional delay periods of the same or varying amounts of time can be added. The amount of data in the initial set of data can also be defined to reduce the potential for prematurely emptying the flow-through buffer or overfilling the flow-through buffer.

While FIG. 3 is discussed in terms of communicating data to a flow-through buffer at a PCI-to-PCI bridge, it should be noted that embodiments of the present invention can be implemented using non-PCI bus architectures (e.g., other bus architectures known in the art) and can be implemented for buffers between data transport mediums of different types (e.g., a buffer at a PCI-to-ISA converter). It should be further noted that embodiments of the present invention can be implemented for any system in which overfill of a flow-through type buffer is of concern, whether the buffer is filled by transferring data a over a bus (e.g., a buffer at a bus bridge), a network (e.g., a buffer at a network router), a wireless connection or other data transport medium. Moreover, while the initiator and target are described, for the sake of example, as being on separate busses, the target and initiator can be connected to the same data transport medium.

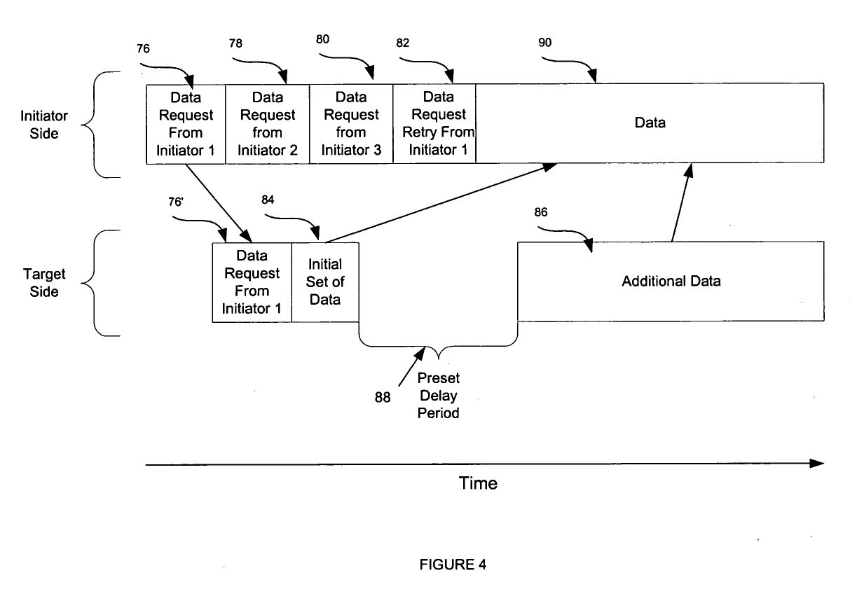

FIG. 4 is a diagrammatic representation of a data flow according to one embodiment of the present invention. For the sake of example, it is assumed that (i)there are three PCI initiators attempting to take control of the PCI bus to which they are connected by making requests to PCI targets, (ii) the overhead for each request is approximately equal to the time it would take to transfer 64 bytes (i.e., the overhead is equivalent to 64 bytes), (iii) the flow-through buffer at the PCI bridge has 64 bytes of storage and (iv) the data request from the first PCI initiator requests 512 bytes of data.

Each of the three PCI initiators can attempt to take control of the initiator side PCI bus (i.e., participate in “bus mastering”), by sending data requests 76, data request 78 and data request 80, respectively. Because data request 76 is the first data request, the associated PCI initiator can gain control of the initiator side PCI bus. Requests from the other initiators can be retried. The PCI initiator can forward data request 76 to the PCI bridge, which can, in turn, forward the data request (represented by data request 76′) to the appropriate PCI target. In response, the PCI target can send an initial set of data 84 to the PCI bridge. According to one embodiment of the present invention, the initial set of data can be smaller (or equal to) in amount than the capacity of the flow-through buffer at the PCI bridge (i.e., can be less than or equal to 64 bytes in this example).

The PCI target can then delay sending additional data 86 to the PCI bridge for a predefined delay period 88. After expiration of delay period 88, the PCI target can send additional data 86 to the PCI bridge. The PCI target can begin sending additional data 86 to the PCI bridge before the PCI initiator begins reading data from the flow-through buffer, can send additional data 86 to the PCI bridge at approximately the same time the PCI initiator begins reading data from the flow-through buffer or can begin sending additional data 86 to the PCI buffer after the PCI initiator begins reading data from the flow-through buffer.

From the perspective of the PCI initiator, the PCI initiator can regain access to the PCI bridge by retrying the original request (represented by data request retry 82) before it begins reading data (represented by data 90) from the flow-through buffer. As the PCI initiator reads data from the flow-through buffer, the PCI target can be sending additional data 86 to the flow-through buffer, which the PCI initiator can then read. Thus, the PCI initiator can continue to receive the data requested from the flow through-buffer without having to make any additional data requests. In this manner, the entire 512 bytes initially requested in data request 76 can be communicated from the PCI target to the PCI initiator without requiring an additional data request after the data request retry.

The amount of data in the initial set of data 84 and the delay period 88 can be configured such that additional data 86 will begin to fill the flow-through buffer of the PCI bridge before the flow-through buffer becomes completely empty, but will not overfill the flow-through buffer before the initiator begins to read data from the flow-through buffer. The amount of data in the initial set of data 84 and delay period 88 can be based on the flow-through buffer size, the speeds at which the PCI initiator and PCI target can empty and fill the flow-through buffer and the average amount of time it takes a PCI initiator in a particular system to begin reading data from a flow-through buffer after making a data request.

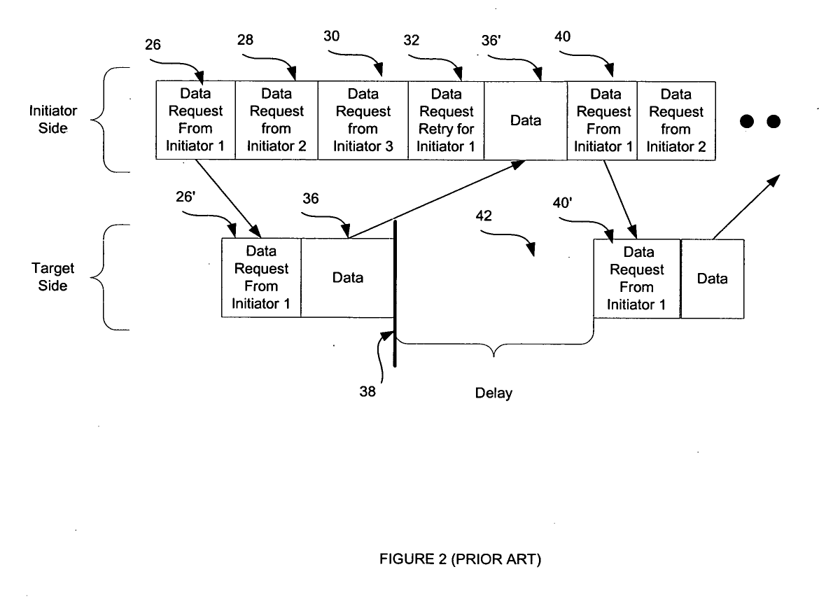

Comparing the example of FIG. 4 with the prior art example of FIG. 2, the efficiency of data transfers can be increased by embodiments of the present invention. In the FIG. 4 example, the efficiency will be approximately 66% (512 bytes of data/(512 bytes of data+(64 bytes of overhead * 3 devices)+64 bytes of overhead for data request retry))). If the initiator side bus and target side bus are each 64 bit/66 MHz busses, the effective throughput is approximately 348 MB/s (528*0.66). Thus, the present invention can provide a higher effective throughput for the same bus configuration. This can occur, according to one embodiment of the present invention, because the PCI target can provide enough data to make sure that the flow-through buffer is not empty, but then, instead of overfilling the flow-through buffer by continuing to send data, can wait for a predefined delay period to allow the PCI initiator to gain access to the flow-through buffer. As the PCI initiator empties the flow-through buffer, the PCI target can write additional data to the buffer, thereby putting the buffer in its “flow-through” mode.

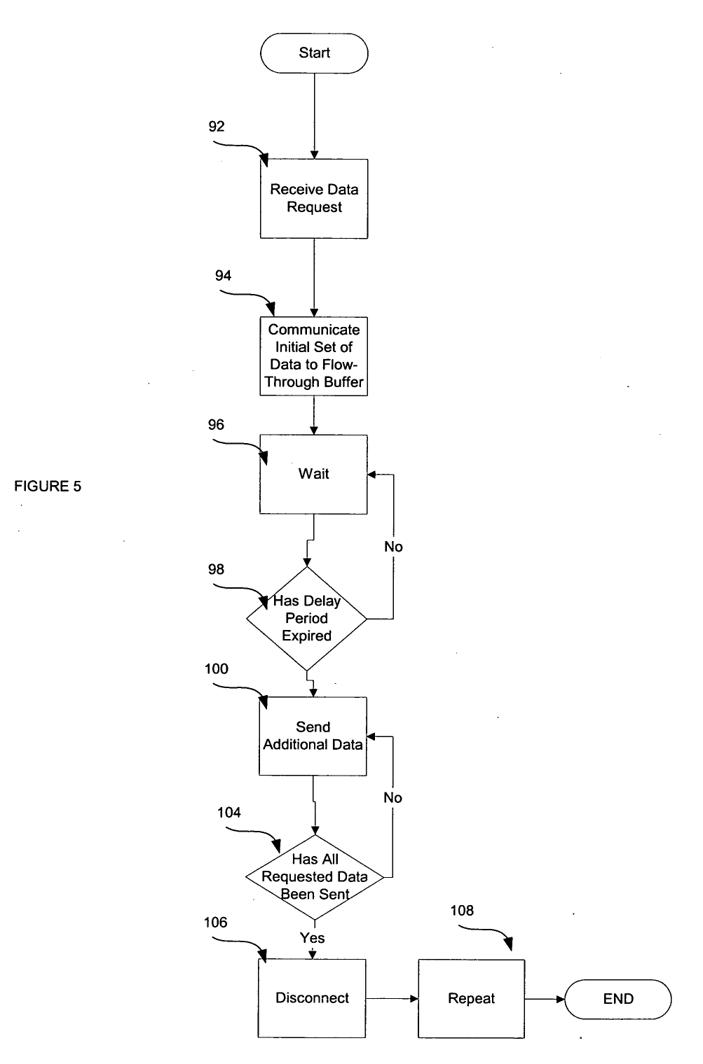

FIG. 5 is a flow chart illustrating one embodiment of a method for transferring data from a target to an initiator using a flow-through buffer. It should be noted that the method of FIG. 5 can be implemented as a hard coded process or through execution of software instructions stored on a computer readable memory. According to one embodiment of the present invention, the target, at step 92 can receive a data request. In response, the target, at step 94, can forward an initial set of data to a device having a flow-through buffer (e.g., a PCI bridge or other device with flow-through buffer known in the art). The amount of data in the initial set of data can be less than the capacity of the flow-through buffer to which the initial set of data is transmitted.

After the initial set of data has been sent to the flow-through buffer, the target can wait (step 96) for a predetermined delay period. The target can determine whether the delay period has passed (step 98) and if the delay period has not passed, can continue to wait (i.e., return to step 96). When, on the other hand, the target determines that the delay period has passed, the target can begin transmitting additional data (step 100) to the flow-through buffer. The target can continue sending additional data to the flow-through buffer (represented at step 104) until all the data requested in the data request has been transmitted. Once all the data has been transmitted, the target, at step 106, can disconnect from the device having the flow-through buffer. The steps of FIG. 5 can be arbitrarily repeated (step 108).

In one embodiment of the present invention, the target can further insert additional delay periods when transmitting the additional data. This can be done, for example, to prevent overfilling of the flow-through buffer if an initiator cannot read data from the flow-through buffer as quickly as the target can write to the flow-through buffer. In this embodiment of the present invention, the target can send an initial set of data to the device which a flow-through buffer, wait a predetermined delay period, send additional data to the device with the flow-through buffer, wait a second delay period, send more additional data to the device with the flow-through buffer. The target can insert an arbitrary number of delay periods when sending data requested in a data request to the device with a flow-through buffer.

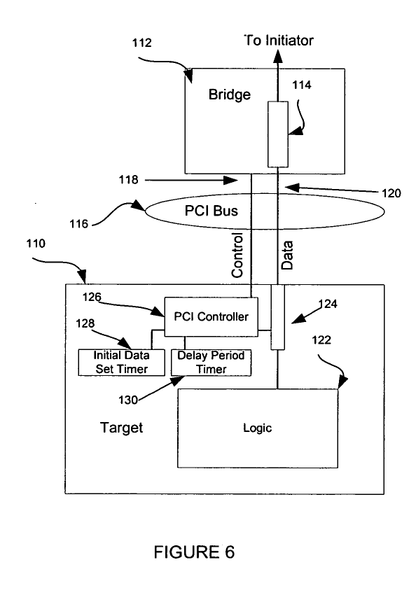

FIG. 6 is a diagrammatic representation of one embodiment of a system for transmitting data from a PCI target 110 to a PCI bridge 112 that includes a flow-through buffer 114. In FIG. 6, PCI target 110 and PCI bridge 112 can be connected by PCI bus 116, which can include control lines 118, data lines 120, address lines (not shown) and a chip set (not shown) to control access to PCI bus 116. PCI target 110 can include backend logic 122 for carrying out various data processing functions related to the overall functionality of PCI target 110. For example, backend logic 122 can carryout processes related to network communications if PCI target 110 is a network interface device, process related to data storage of PCI target 110 is a PCI hard drive or other process known in the art. In one embodiment of the present invention, PCI target 110 can be a dual port memory controller in a storage router, such as the Crossroads 10,000 storage router (Crossroads is a trademark of Crossroads Systems, Inc. of Austin, Tex.). The memory controller can be implemented as programmed logic in a Altera 20K400E Programmable Chip. Backend logic 122 can control access to one or memories in the router.

PCI target 110 can include a data buffer 124 to buffer data received from backend logic 122 for transmission over PCI bus 116. A PCI controller 126, which can operate according to any PCI control logic known in the art, can govern when data is written to or from data buffer 124. PCI controller 126 can be responsive to signals from an initial data set timer circuit 128 and a delay period timer circuit 130 when determining when to send data from data buffer 124. Initial data set timer circuit 128 and delay period timer circuit 130 can include any timer logic known in the art.

In operation, PCI target 110 can receive a data request from PCI bridge 112 via PCI bus 116. PCI controller 126 can begin transmitting an initial data set from data buffer 124 over PCI bus 116. PCI controller 126 can also initialize initial data set timer circuit 128 to begin a count down (or count up). Initial data set timer circuit 128 can assert a timer signal to PCI controller 126. In one embodiment of the present invention, when the timer signal changes states (goes from high to low, or low to high, depending on implementation), the PCI controller 126 can cease sending data from data buffer 124 to PCI bridge 112 and delay period timer circuit 130 can be initialized. Delay period timer circuit 130 can begin a count down (or count up). When the delay period timer signal changes states (goes from high to low or low to high), PCI controller 126 can resume sending data from data buffer 124 to flow-through buffer 114 at PCI bridge 112. Thus, the amount of data in the initial set of data can be governed by initial data set timer 128 and the delay period can be governed by delay period timer 130. PCI target 110, therefore, can essentially act as a state machine capable of transmitting data to the PCI bridge (or other device) based on the state of various timer signals.

According to one embodiment of the present invention, initial data set timer circuit 128 can be configured such that PCI controller 126 will cause the initial set of data to be sent for a short enough period of time that the amount of data in the initial set of data will not exceed the capacity of flow-through buffer 114. Additionally, delay period timer circuit 128 can be configured such that PCI controller 126 will delay sending additional data from data buffer 124 to PCI bridge 114 for a sufficient period of time such that the likelihood of flow-through buffer 114 becoming overfilled is reduced.

PCI controller 126 can also be responsive to control signals from PCI bridge 112. For example, PCI bridge 112 can indicate via control lines 118 that flow-through buffer 112 can not receive additional data due, for example, to an error communicating with the PCI target. PCI controller 126 can process the control signals to determine if it should forward data to the bridge, disconnect from the bridge or take other actions as would be understood to those of ordinary skill in the art.

In the example of FIG. 6, PCI controller 126 is responsive to the state of clock signals from various timer circuits. In other embodiments of the present invention, PCI controller 126 determines how much data to send in the initial set of data and how long the delay period should be based on a processor executing software instructions stored on a computer readable medium. The software instructions can be executable to send an initial set of data that is less than a buffer capacity to a device having a flow through buffer, delay for a predefined delay period and send additional data to the device having the flow-through buffer. The PCI target can, thus, determine how much data should be sent as the initial set of data and how long to delay before sending additional data using hardware, software or a combination of hardware and software.

As can be understood from the foregoing, embodiments of the present invention can provide systems and methods for transmitting data to a flow-through buffer that reduces the likelihood of overfilling the flow-through buffer. One embodiment of the present invention includes a system for communicating data comprising a device containing a flow-through buffer having a buffer capacity, a first data transport medium coupled to the device and a target coupled to the first data transport medium. The target device can be configured to receive a data request from the device, send an initial set of data to the device that is smaller than the buffer capacity, delay a predetermined delay period, and send additional data to the device when the delay period has elapsed.

The system can further comprise a second data transport medium coupled to the device, an initiator coupled to the second data transport medium. The initiator can be configured to generate the data request, send the data request to the device, receive data from the flow-through buffer. According to one embodiment of the present invention, the predetermined delay period can be configured to allow the initiator to begin receiving data from the flow-through buffer before the target sends the additional data.

Another embodiment of the present invention can include a method of communicating data comprising, at a target: sending an initial set of data to a device containing a flow-through buffer with a buffer capacity, wherein the amount of data in the initial set of data is less than the buffer capacity, waiting to send additional data to the device containing the flow-through buffer for a predetermined delay period and sending the additional data to the device containing the flow-through buffer after the predetermined delay period. The method can further include, at the device containing the flow-through buffer: receiving the data request from an initiator, forwarding the data request to the target, receiving the initial set of data from the target, storing the initial set of data in the flow-through buffer, sending data in the flow-through buffer to the initiator, receiving at least a portion of the additional data from the target before the flow-through buffer is empty, storing the at least a portion of the additional data in the flow-through buffer and continuing to send data in the flow-through buffer to the initiator according to a flow-through mode.

Yet another embodiment of the present invention can include a device for communicating data comprising: a data buffer for storing data, a PCI controller configured to control transmission of data from the data buffer, an initial data set timer circuit coupled to the PCI controller, and a delay period timer circuit coupled to the PCI controller. The PCI controller can be responsive to a data request to send an initial set of data from the data buffer to a device containing a flow-through buffer for a period of time governed by the initial data set timer circuit. The PCI controller can also be configured to delay sending additional data to the device containing the flow-through buffer for a delay period governed by the delay period timer circuit.

While the present invention has been described with reference to particular embodiments, it should be understood that the embodiments are illustrative and tat the scope of the invention is not limited to these embodiments. Many variations, modifications, additions and improvements to the embodiments described above are possible. It is contemplated that these variations, modifications, additions and improvements fall within the scope of the invention as detailed in the following claims.

What is claimed is:

1. A system for communicating data comprising:
a device containing a flow-through buffer having a buffer capacity;
a first data transport medium coupled to the device;
a target coupled to the first data transport medium, wherein the target is configured to:
receive a data request from the device;
send an initial set of data to the device;
delay a predetermined delay period; and
send additional data to the device when the delay period has elapsed.

2. The system of claim 1, further comprising:
a second data transport medium coupled to the device;
an initiator coupled to the second data transport medium, wherein the initiator is configured to:
generate the data request;
send the data request to the device; and
receive data from the flow-through buffer.

3. The system of claim 2, wherein the predetermined delay period is configured to allow the initiator to begin receiving data from the flow-through buffer before the target sends the additional data.

4. The system of claim 2, wherein the first data transport medium is a first PCI bus and the second data transport medium is a second PCI bus.

5. The system of claim 4, wherein the first PCI bus and the second PCI bus are symmetrical.

6. The system of claim 4, wherein the first PCI bus and the second PCI bus are asymmetrical.

7. The system of claim 4, wherein the target is a PCI target, the initiator is a PCI initiator and the device containing the flow-through buffer is a PCI bridge.

8. The system of claim 2, wherein the first data transport medium is a first bus and the second data transport medium is a second bus.

9. The system of claim 1, wherein the initial set of data is smaller in amount than the buffer capacity.

10. A method of communicating data comprising:
at a target:
sending an initial set of data to a device containing a flow-through buffer with a buffer capacity, wherein the amount of data in the initial set of data is configured to not overfill the buffer;
waiting to send additional data to the device containing the flow-through buffer for a predetermined delay period; and
sending the additional data to the device containing the flow-through buffer after the predetermined delay period.

11. The method of claim 10, further comprising:
receiving a data request at the target, wherein the initial set of data is sent in response to the data request.

12. The method of claim 11, further comprising:
at the device containing the flow-through buffer:
receiving the data request from an initiator;
forwarding the data request to the target;
receiving the initial set of data from the target;
storing the initial set of data in the flow-through buffer;
communicating data in the flow-through buffer to the initiator;
receiving at least a portion of the additional data from the target before the flow-through buffer is emptied;
storing the at least a portion of the additional data in the flow-through buffer; and
continuing to send data in the flow-through buffer to the initiator according to a flow-through mode.

13. The method of claim 12, further comprising:
at the device containing the flow-through buffer:
receiving a data request retry from the initiator prior to communicating data in the flow-through buffer to the initiator.

14. The method of claim 12, wherein the predetermined delay period is configured to allow the initiator to begin receiving data stored in the flow-through buffer before the additional data is sent to the device containing the flow-through buffer.

15. The method of claim 12, wherein the predetermined delay period is configured to be short enough to prevent the flow-through buffer from becoming empty before the additional data is sent to the device containing the flow-through buffer.

16. The method of claim 10, wherein the predetermined delay period is configured to allow an initiator to begin receiving data stored in the flow-through buffer before the additional data is sent to the device containing the flow-through buffer.

17. The method of claim 10, wherein the initial set of data is smaller in amount than the buffer capacity.

18. A device for communicating data comprising:
a data buffer for storing data;
a PCI controller configured to control transmission of data from the data buffer;
an initial data set timer circuit coupled to the PCI controller; and
a delay period timer circuit coupled to the PCI controller.

19. The device of claim 18, wherein the PCI controller is responsive to a data request to send an initial set of data from the data buffer to a device containing a flow-through buffer for a period of time governed by the initial data set timer circuit.

20. The device of claim 19, wherein the PCI controller is configured to delay sending additional data to the device containing the flow-through buffer for a delay period governed by the delay period timer circuit.

21. The device of claim 19, wherein the initial data set timer circuit is configured to allow the PCI controller to send initial set of data containing an amount of data that is less than a buffer capacity of the flow-through buffer.

22. The device of claim 21, wherein the delay period timer circuit is configured to cause the PCI controller to delay sending the additional data to the device containing the flow-through buffer for a sufficient period of time to allow another device to begin receiving data from the flow-through buffer.
